(19) United States
(12) Patent Application Publication
(10) Pub. No.: US 2015/0093576 A1
(43) Pub. Date: Apr. 2, 2015

(54) Carbon Nanotubes and Method for Preparing the Same

(71) Applicant: Samsung SDI Co., Ltd., Yongin-si (KR)

(72) Inventors: Seung Yong BAE, Uiwang-si (KR); Yun Tack LEE, Uiwang-si (KR); Byeong Yeol KIM, Uiwang-si (KR); Joong In KIM, Uiwang-si (KR); Sung Hee AHN, Uiwang-si (KR)

(21) Appl. No.: 14/499,575

(22) Filed: Sep. 29, 2014

(30) Foreign Application Priority Data
Sep. 30, 2013 (KR) 10-2013-0116961
Apr. 1, 2014 (KR) 10-2014-0038825

(51) Int. Cl. C01B 31/02; B01J 23/889

(52) U.S. Cl. CPC C01B 31/0233; B01J 23/8892; C01B 2202/30; C01B 2202/36; Y10S 977/742; Y10S 977/843; B82Y 40/00
USPC 428/402; 423/447.2; 502/324; 423/447.3; 977/742; 977/843

(57) ABSTRACT

Disclosed herein are carbon nanotubes and a method of manufacturing the same. The carbon nanotubes include at least one element selected from aluminum (Al), magnesium (Mg) and silicon (Si) and at least one metal selected from cobalt (Co), nickel (Ni), iron (Fe), manganese (Mn) and molybdenum (Mo), and have an intensity ratio

(ID/IG) of about 1.10 or less as measured by Raman spectroscopy and a carbon purity of about 98% or higher. The carbon nanotubes prepared by the method can be controlled in terms of carbon purity and preparation yield while eliminating the need for post-refining treatment.

### CROSS-REFERENCE TO RELATED APPLICATIONS

This application claims priority under 35 USC Section 119 to and the benefit of Korean Patent Application No. 10-2013-0116961, filed on Sep. 30, 2013 in the Korea Intellectual Property Office, and Korean Patent Application No. 10-2014-0038825, filed on April 1, 2014 in the Korea Intellectual Property Office, the entire disclosure of each of which is incorporated herein by reference.

### FIELD OF THE INVENTION

The present invention relates to carbon nanotubes and a method for preparing the same.

### BACKGROUND

Carbon nanotubes (CNTs), discovered by Iijima in 1991, have a hexagonal honeycomb structure in which each carbon atom is bonded to three other surrounding carbon atoms. This hexagonal structure is repeatedly rolled into a cylindrical or tubular shape.

Since their discovery, carbon nanotubes have been the subject of numerous articles and patent applications focused on theoretical research and industrial applicability thereof In particular, carbon nanotubes have good mechanical characteristics, electrical selectivity, excellent field emission properties, high hydrogen capacity, polymer composite properties, and the like, and, thus, are considered an ideal new material.

Carbon nanotubes are mainly manufactured by arc discharge, laser ablation, chemical vapor deposition, and the like. Carbon nanotubes are categorized into single-walled, double-walled, and multi-walled carbon nanotubes according to their shape. However, although various synthesis methods and structures are used for carbon nanotubes, these methods have a limitation in terms of production cost or the production of high purity carbon nanotubes in high yield.

Accordingly, in recent years, studies on preparing catalysts suitable for preparation of high purity carbon nanotubes in high yield as well as on a process for preparing carbon nanotubes in large amounts have been conducted. Above all, thermo-chemical vapor deposition requires a relatively simple apparatus and is greatly advantageous for mass preparation. The thermo-chemical vapor deposition may be mainly divided into a fixed bed reactor type and a fluidized bed reactor type.

With the fixed bed reactor, carbon nanotubes can be prepared without being significantly affected by the shape and size of metal supports. However, the fixed bed reactor does not have a sufficient internal space to produce carbon nanotubes in high yield. On the other hand, the fluidized bed reactor, which stands vertically, allows continuous preparation of carbon nanotubes more easily than the fixed bed reactor.

Since the fluidized bed reactor enables continuous preparation of carbon nanotubes in a larger amount at a time than the fixed bed reactor, many studies on the fluidized bed reactor are in progress. However, unlike the fixed bed reactor, the fluidized bed reactor has a problem in that the shape or size of metal supports must be maintained uniformly so as to uniformly fluidize the metal supports.

Korean Patent Application No. 2007-7010697 discloses a catalyst which contains Mn, Co and a support material to facilitate preparation of carbon nanotubes in high yield. However, this method requires a complicated process including a precipitation method to prepare the catalyst and the prepared catalyst is not uniform in shape, thereby making it difficult to treat the particles of the catalyst as well as to use the catalyst in a continuous process.

In order to enlarge the application range of carbon nanotubes, it is necessary to produce high purity carbon nanotubes. In particular, recently, carbon nanotubes are expected to be used as conductive materials or assistant additives for secondary batteries. However, impurities caused by metal catalysts contained in carbon nanotubes can have an adverse influence on stability of the secondary battery, thereby obstructing the use of carbon nanotubes.

In Carbon 41, 2585-2590 (2003), there is proposed a process in which carbon nanotubes are subjected to high temperature treatment to remove impurities in order to increase the purity of carbon nanotubes. Moreover, many studies have been carried out to remove impurities through strong acid treatment. However, improving the purity of carbon nanotubes through introduction of such post-treatment steps can cause deterioration in inherent properties of the carbon nanotubes. In addition, post-treatment steps can require additional costs, thereby making it difficult to use carbon nanotubes for secondary batteries.

### SUMMARY

Embodiments of the invention relate to carbon nanotubes. The carbon nanotubes include: at least one element selected from aluminum (Al), magnesium (Mg) and silicon (Si); and at least one metal selected from cobalt (Co), nickel (Ni), iron (Fe), manganese (Mn) and molybdenum (Mo), and have an intensity ratio (ID/IG) of about 1.10 or less as measured by Raman spectroscopy and a carbon purity of about 98% or higher.

The carbon nanotubes may include about 20 ppm to about 2,000 ppm of aluminum (Al), magnesium (Mg) and/or silicon (Si), about 40 ppm to about 9,000 ppm of cobalt (Co), and about 40 ppm to about 9,000 ppm of manganese (Mn).

The carbon nanotubes may have an average particle diameter from about 10 nm to about 35 nm.

Embodiments of the invention also relate to a supported catalyst for preparing carbon nanotubes. The supported catalyst for preparing carbon nanotubes includes at least one metal catalyst selected from the group consisting of Co, Ni, Fe, Mn and Mo; and at least one support material selected from the group consisting of aluminum oxide, magnesium oxide and silica, and is a hollow type.

The supported catalyst may have an average particle diameter of about 10 μm to about 500 μm.

The supported catalyst may have a mole ratio as follows:

Al, Mg or Si:Co:Mn=1:x:y, wherein about 0.8≦x≦4.0 and about 0.1≦y≦8.0.

The supported catalyst may have a sphericity of about 0.1 to about 1.

Further embodiments of the invention relate to a method for preparing a supported catalyst. The method includes providing an aqueous catalyst solution; spraying the aqueous catalyst solution as droplets; and baking the sprayed droplets, wherein the aqueous catalyst solution includes at least one metal catalyst selected from the group consisting of Co, Ni, Fe, Mn and Mo; and at least one support material selected from the group consisting of aluminum oxide, magnesium oxide and silica.

The aqueous catalyst solution may have a mole ratio as follows:

Al, Mg or Si:Co:Mn=1:x:y, wherein about 0.8≦x≦4.0 and about 0.1≦y≦8.0.

The droplets of the aqueous catalyst solution upon spraying may have a size of about 10 μm to about 1000 μm.

The aqueous catalyst solution may further include polyvinylpyrrolidone (PVP), polyvinylalcohol (PVA), polyvinylchloride (PVC) and/or an epoxy-based polymer as a polymer binder.

The baking may include heat treatment at about 450° C. to about 650° C.

Yet other embodiments of the present invention relate to a method for preparing carbon nanotubes using the supported catalyst.

The method may include charging the supported catalyst in a furnace; and preparing carbon nanotubes at about 650° C. to about 750° C. for about 40 to 90 minutes while supplying a carbon source.

The carbon source may include ethylene, methane, and/or liquid petroleum gas. In the method, carbon nanotubes may be prepared in a yield of about 80 (gCNT/catalyst) to about 200 (gCNT/gcatalyst).

### BRIEF DESCRIPTION OF THE DRAWINGS

FIG. 1 is a graph illustrating yield versus time in preparation of carbon nanotubes using a method for preparing carbon nanotubes according to one embodiment of the present invention.

FIG. 2 is a Raman spectroscopy graph of carbon nanotubes prepared in Example 1.

FIG. 3 is a Raman spectroscopy graph of carbon nanotubes prepared in Comparative Example 1.

FIG. 4 is a thermal gravimetric analysis (TGA) graph of carbon nanotubes prepared in Example 4.

### DETAILED DESCRIPTION

Exemplary embodiments now will be described more fully hereinafter in the following detailed description, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

Carbon Nanotubes

One embodiment of the present invention relates to carbon nanotubes. As used herein, the carbon nanotubes refer to an aggregate of catalyst-carbon nanotubes prepared on a supported catalyst and including metal components of the supported catalyst.

In one embodiment of the invention, the carbon nanotubes may include at least one element selected from aluminum (Al), magnesium (Mg) and silicon (Si), and at least one metal selected from cobalt (Co), nickel (Ni), iron (Fe), manganese (Mn) and molybdenum (Mo). The carbon nanotubes have an intensity ratio (ID/IG) of about 1.10 or less as measured by Raman spectroscopy and a carbon purity of about 98% or higher.

The carbon nanotubes may include about 20 ppm to about 2,000 ppm, about 40 ppm to about 1,500 ppm, or about 50 ppm to about 1,000 ppm of aluminum (Al), magnesium (Mg) and/or silicon (Si), about 40 ppm to about 9,000 ppm, about 70 ppm to about 6,750 ppm, or about 100 ppm to about 4,500 ppm of cobalt (Co), and about 40 ppm to about 9,000 ppm, about 70 ppm to about 6,750 ppm, or about 100 ppm to about 4,500 ppm of manganese (Mn). The amounts of metals contained in the carbon nanotubes may be measured, for example, using an ICP-OES (Inductively Coupled Plasma Optic Emission Spectrometer).

The carbon nanotubes may have an average particle diameter of about 10 nm to about 35 nm, for example, 10 nm, 11 nm, 12 nm, 13 nm, 14 nm, 15 nm, 16 nm, 17 nm, 18 nm, 19 nm, 20 nm, 21 nm, 22 nm, 23 nm, 24 nm, 25 nm, 26 nm, 27 nm, 28 nm, 29 nm, 30 nm, 31 nm, 32 nm, 33 nm, 34 nm, or 35 nm.

The carbon nanotubes of the present invention may be relatively evaluated as to a degree of surface crystallinity by measuring an intensity ratio (ID/IG) on a Raman spectroscopy graph.

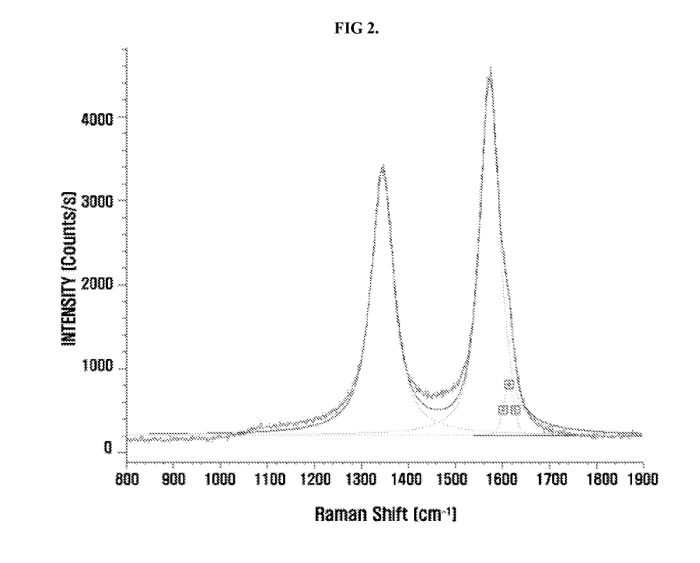

Referring to FIG. 2, for the carbon nanotubes, a peak appearing near 1340 cm⁻¹, known as a D-mode, and a peak appearing near 1580 cm⁻¹, known as a G-mode, can be observed in the Raman spectroscopy graph.

Each peak appears in a typical carbon material such as a graphite material. Specifically, the D mode peak is a characteristic peak representing defects in crystals, while the G mode peak is a characteristic peak which commonly appears in a typical graphite-based material, and indicates that adjacent hexagonal carbon atoms oscillate in opposite directions to one another, i.e. hexagonal crystal structures are well arranged without defects. Thus, if an intensity ratio (ID/IG) of the D mode peak intensity value (ID) to the G mode peak intensity value (IG) is measured as about 1.10 or less, it is considered that the carbon nanotubes have excellent crystallinity. The carbon nanotubes of the invention manufactured using the supported catalyst including Co and/or Mn, for example Co and Mn, can have an intensity ratio (ID/IG) of about 1.10 or less as measured by Raman spectroscopy.

The carbon nanotubes according to the present invention have a carbon purity of about 98% or higher, for example can have a carbon purity of about 98.5% to about 99.9%. Thus, the carbon nanotubes contain little impurities and do not require any post-treatment for removing impurities. As a result, the carbon nanotubes according to the present invention can be used as a conductive material and/or an assistant additive for secondary batteries.

Supported Catalyst

Another embodiment of the invention relates to a supported catalyst for preparing carbon nanotubes. The supported catalyst has a metal catalyst supported on a support material and is a hollow type. In addition, the supported catalyst may have porosity.

According to the present invention, in order to prepare high purity carbon nanotubes in high yield, the supported catalyst can include a metal catalyst including Co and/or Mn in an oxide support material. The metal catalyst can be distributed on the outer surface and/or inside of the supported catalyst. In one embodiment, the oxide support material may be aluminum oxide (Al₂O₃), magnesium oxide, and/or silica, for example aluminum oxide. In the supported catalyst including the metal catalyst and the support material including the metal catalyst, the metal catalyst may include Co, Ni, Fe, Mn and/or Mo, for example Co and Mn, and as another example an oxide and/or hydrate of Co and Mn. When the carbon nanotubes are to be used as a conductive material for secondary batteries, the metal catalyst does not include Fe and Mo.

In one embodiment, the supported catalyst may have a mole ratio as follows:

Al, Mg or Si:Co:Mn=1:x:y, wherein about 0.8≦x≦4.0, about 0.1≦y≦8.0.

Within this range, the carbon nanotubes can be prepared in high yield and can have not only excellent crystallinity and an increased diameter, but also high carbon purity, thereby eliminating the need for post-treatment.

The supported catalyst may have an average particle diameter of about 10 μm to about 500 μm. Further, single-walled carbon nanotubes (SWNT), double-walled carbon nanotubes (DWNT), or multi-walled carbon nanotubes (MWNT) may be selectively prepared by adjusting the amounts of the metal catalysts Co and Mn.

The supported catalyst may have a sphericity of about 0.1 to about 1.

Preparation of Supported Catalyst

In one embodiment of the invention, a method for preparing a supported catalyst includes providing an aqueous catalyst solution; spraying the aqueous catalyst solution in droplets; and baking the sprayed droplets, wherein the aqueous catalyst solution includes at least one metal catalyst selected from the group consisting of Co, Ni, Fe, Mn and Mo; and at least one support material selected from the group consisting of aluminum oxide, magnesium oxide and silica.

Examples of the metal catalyst may include without limitation Co(NO₃)₂ and/or Mn(NO₃)_{2,} and/or may include an oxide and/or hydrate of Co and/or Mn. For example, the metal catalyst may include cobalt nitrate nonahydrate.

Examples of the support material may include without limitation aluminum oxide, magnesium oxide, silica, and the like. These materials may be used alone or in combination thereof In exemplary embodiments, aluminum oxide can be used as the support material.

In one embodiment, the aqueous catalyst solution may have a mole ratio as follows:

Support material (Al, Mg, or Si):metal catalyst (Co):metal catalyst (Mn)=1:x:y, wherein about 0.8≦x≦4.0 and about 0.1≦y≦8.0.

Within this range, the carbon nanotubes can be prepared in high yield and can have not only excellent crystallinity and an increased diameter, but also high carbon purity, thereby eliminating the need for post-treatment.

The metal catalyst and the support material are each dissolved in water to be mixed with each other in an aqueous solution form. The aqueous catalyst solution of the metal catalyst and support material is completely dissociated through stirring. If necessary, active agents may be added to the aqueous catalyst solution to minimize or prevent agglomeration of nano-scale metal catalysts during sintering at high temperature. Examples of the active agents may include without limitation molybdenum (Mo)-based active agents such as ammonium molybate tetrahydrate, citric acid, and the like, and combinations thereof.

The aqueous catalyst solution may further include a polymer binder to prevent particles from being broken up during formation into a spherical shape and being subjected to a baking process. Examples of the polymer binder may include without limitation polyvinylalcohol (PVA), polyvinylchloride (PVC), epoxy-based polymers, and the like, and combinations thereof.

Subsequently, the aqueous catalyst solution containing the metal catalyst and the support material is formed into spherical particles by spray drying. By means of spray drying, the supported catalyst having a uniform spherical shape and size can be produced in a large amount. In spray drying, a feed in a fluid state is sprayed into hot drying gas to be dried substantially instantaneously. Such very rapid drying results from considerable increase in surface area caused by atomization of the feed using an atomizer

In one embodiment, the droplets of the aqueous catalyst solution in the spraying stage may have a size from about 10 μm to about 1000 μm. Within this range, a particle diameter of the supported catalyst can be adjusted to fall into the range as set forth below.

In one embodiment, the supported catalyst may have an average particle diameter of about 10 μm to about 500 μm. Further, single-walled carbon nanotubes (SWNT), double-walled carbon nanotubes (DWNT), or multi-walled carbon nanotubes (MWNT) may be selectively prepared by adjusting the amounts of metal catalysts Co and Mn.

In one embodiment, the supported catalyst may have a sphericity of about 0.1 to about 1.

Depending on the density of the solution, a spraying amount, and an RPM of an atomizer disc, an apparatus for spray drying may have influence on the particle size of the catalyst powder.

Examples of spraying methods include spraying through nozzles and spraying water drops formed by rotation of the disc. In exemplary embodiments, disc type spraying can be used to prepare supported catalyst powder having a more uniform particle size. The disc may be a vane type or a pin type. The size and distribution of the particles may be adjusted according to an RPM of the disc as well as the dose and density of the solution.

The catalyst powder prepared by spray drying is subjected to heat treatment by baking. This baking process enables crystallization of the catalyst powder, thereby preparing a supported catalyst of spherical particles which exhibit improved catalyst activity and have porosity on the surface thereof Here, it is possible to control a diameter and properties of carbon nanotubes according to baking temperature and time. The baking process may include heat treatment at about 450° C. to about 650° C.

Fabrication of Carbon Nanotubes

A method for preparing carbon nanotubes may include preparing carbon nanotubes by thermal chemical vapor deposition (TCVD) using the supported catalyst. The supported catalyst is placed in a reactor, followed by supplying a carbon source under atmospheric pressure at about 650° C. to about 800° C., thereby fabricating carbon nanotubes. For example, the supported catalyst can be placed in a reactor, followed by supplying a carbon source under atmospheric pressure at about 650° C. to about 750° C. for about 40 to about 90 minutes, thereby preparing carbon nanotubes.

Examples of the carbon source may include without limitation methane, ethylene, acetylene, liquid petroleum gas, and the like, and mixtures thereof. In addition, a hydrogen gas may be supplied together with a hydrocarbon gas. The hydrogen gas serves to reduce oxygen adhered to the catalyst into water so as to avoid possible decomposition of carbon nanotubes at high temperature.

The carbon nanotubes prepared by the method for preparing carbon nanotubes have a carbon purity of about 98% or higher, for example, from about 98.5% to about 99.9%, thereby eliminating the need for post-treatment such as acid treatment.

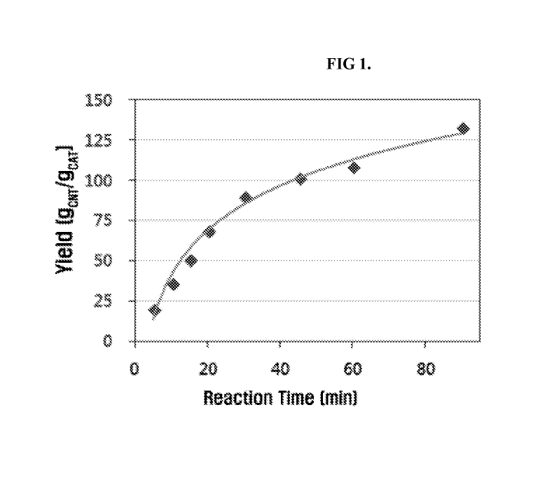

FIG. 1 is a graph illustrating yield versus time in preparation of carbon nanotubes using a method for preparing carbon nanotubes according to one embodiment of the invention. Referring to FIG. 1, in the method according to the invention, it can take about 45 minutes until a preparation yield of about 100 (gCNT/gcatalyst) is reached. Thus, the method is characterized by a high growth rate.

In the method according to the present invention, the carbon nanotubes may be prepared in a yield of about 80 (gCNT/gcatalyst) to about 200 (gCNT/gcatalyst).

The carbon nanotubes prepared by the method according to the present invention may have an average particle diameter of about 10 nm to about 35 nm, for example, 10 nm, 11 nm, 12 nm, 13 nm, 14 nm, 15 nm, 16 nm, 17 nm, 18 nm, 19 nm, 20 nm, 21 nm, 22 nm, 23 nm, 24 nm, 25 nm, 26 nm, 27 nm, 28 nm, 29 nm, 30 nm, 31 nm, 32 nm, 33 nm, 34 nm, or 35 nm.

The carbon nanotubes prepared by the method according to the present invention may include about 20 ppm to about 2,000 ppm of aluminum (Al), magnesium (Mg) and/or silicon (Si), about 40 ppm to about 9,000 ppm of cobalt (Co), and about 40 ppm to about 9,000 ppm of manganese (Mn). The amounts of metals contained in the carbon nanotubes may be measured, for example, using an ICP-OES (Inductively Coupled Plasma Optic Emission Spectrometer).

Next, the present invention will be described in more detail with reference to examples. However, it should be noted that these examples are provided for illustration only and should not be construed in any way as limiting the invention.

### Example 1

Preparation of catalyst: As hydrates, 7.5 g of Al(NO₃)₃.9H₂O, 17.5 g of Co(NO₃)₂.6H₂O, and 28.8 g of Mn(NO₃)₂.6H₂O are dissolved in 50 ml of water, followed by adding 1 g of a polymer binder (PVP), thereby preparing an aqueous catalyst solution. The aqueous catalyst solution is spray-dried in droplets measuring 10 μm to 1000 μm in size using a spray drying device at 3500 rpm rotating speed of atomizer and 280° C. hot air condition. The spray-dried particles are subjected to heat treatment at 550° C. in the presence of air, thereby preparing a supported catalyst.

Preparation of Carbon Nanotube: Carbon nanotubes are prepared by growing the carbon nanotubes on the supported catalyst by supplying ethylene at 700° C. for 60 minutes.

### Examples 2-17 and Comparative Examples 1-5

Carbon nanotubes are prepared in the same manner as in Example 1 except that supported catalysts having a mole ratio as listed in Table 1 were used.

TABLE 1

| | Mole ratio | | | | |
|---|---|---|---|---|---|
| | Al | Co | Fe | Mn | Mo |
| Example 1 | 1.0 | 3.0 | — | 5.0 | — |
| Example 2 | 1.0 | 3.0 | — | 4.0 | — |
| Example 3 | 1.0 | 3.0 | — | 3.0 | — |
| Example 4 | 1.0 | 3.0 | — | 2.0 | — |
| Example 5 | 1.0 | 2.5 | — | 4.0 | — |
| Example 6 | 1.0 | 2.5 | — | 3.0 | — |
| Example 7 | 1.0 | 2.5 | — | 2.5 | — |
| Example 8 | 1.0 | 2.5 | — | 2.0 | — |
| Example 9 | 1.0 | 2.0 | — | 3.0 | — |
| Example 10 | 1.0 | 2.0 | — | 2.0 | — |
| Example 11 | 1.0 | 2.0 | — | 1.5 | — |
| Example 12 | 1.0 | 2.0 | — | 1.0 | — |
| Example 13 | 1.0 | 1.5 | — | 2.0 | — |
| Example 14 | 1.0 | 1.5 | — | 1.5 | — |
| Example 15 | 1.0 | 1.0 | — | 2.0 | — |
| Example 16 | 1.0 | 1.0 | — | 1.5 | — |
| Example 17 | 1.0 | 1.0 | — | 1.0 | — |
| Comparative | 12.0 | 3.0 | 1.0 | — | 0.5 |
| Example 1 | | | | | |
| Comparative | 1.0 | 0.75 | — | 2.0 | — |
| Example 2 | | | | | |
| Comparative | 1.0 | 0.50 | — | 2.0 | — |
| Example 3 | | | | | |
| Comparative | 1.0 | 3.0 | — | — | — |
| Example 4 | | | | | |
| Comparative | 2.0 | 1.0 | — | 2.0 | — |
| Example 5 | | | | | |

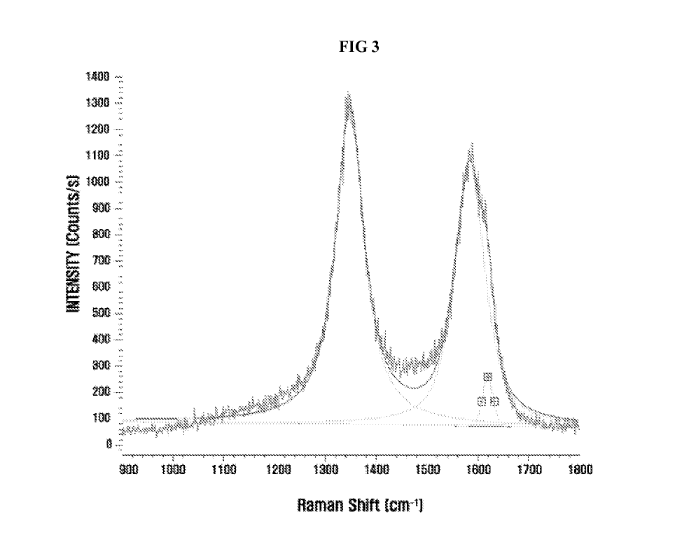

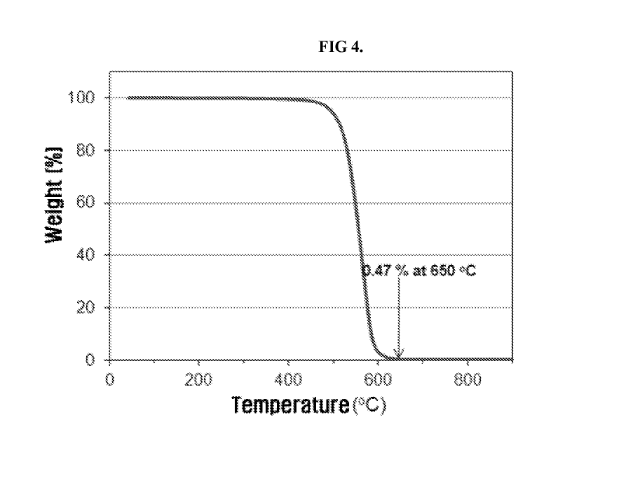

The carbon nanotubes prepared in Examples and Comparative Examples are evaluated as yield per catalyst unit (gCNT/gcatalyst), carbon purity (%), diameter (nm), and intensity ratio (ID/IG) using the following methods. The measured results are shown in Table 3. Raman spectroscopy graphs of the carbon nanotubes prepared in Example 1 and Comparative Example 1 are shown in FIGS. 2 and 3, respectively. A thermal gravimetric analysis (TGA) graph of the carbon nanotubes prepared in Example 4 is shown in FIG. 4.

Yield Per Catalyst Unit

Yields per catalyst unit are calculated by the following equation:

Yield per catalyst unit (gCNT/gcatalyst)=(weight of prepared carbon nanotubes−weight of supported catalyst used)/(supported catalyst used)

Carbon Purity

The carbon purity of the carbon nanotubes is calculated by measuring a weight change of the carbon nanotubes in the presence of air while heating to 900° C. at 10° C./min using a TGA (Thermo Gravimetric Analysis) apparatus (TA instrument Q-5000), and performing analysis on the amounts of residuals.

Diameter

The diameter of the prepared carbon nanotubes is calculated by measuring and averaging the diameters of more than 100 carbon nanotubes on the basis of images of 100,000x magnification using an SEM (Scanning Electron Microscope, Hitachi S-4800).

Raman Analysis

The carbon nanotubes are analyzed using a laser at a wavelength of 514.5 nm by a Renishaw Invia micro-Raman spectroscope (Saclay, France). For carbon nanotubes, measurement is repeated three times under the conditions as listed in Table 2, thereby calculating an intensity ratio (ID/IG).

TABLE 2

| Categories | Measurement conditions | |
|---|---|---|
| Laser | 514.5 | nm |
| Grating | 2400 | l/mm |
| Exposure time | 10 | sec |
| Accumulations | 3 | |
| Measurement area | 100 to 3200 | cm⁻¹ |

TABLE 3

| | | | CNT- | Intensity |
|---|---|---|---|---|
| | Yield | C-purity | diameter | ratio |
| | (g_{CNT}/g_{catalyst}) | (%) | (nm) | (ID/IG) |
| Example 1 | 103 | 99.2 | 25.2 ± 6.8 | 0.8 |
| Example 2 | 128 | 99.5 | 21.8 ± 5.7 | 0.85 |
| Example 3 | 121 | 99.5 | 22.1 ± 6.1 | 0.81 |
| Example 4 | 115 | 99.5 | 21.5 ± 5.8 | 0.86 |
| Example 5 | 97 | 99.1 | 19.7 ± 4.6 | 0.89 |
| Example 6 | 113 | 99.2 | 19.2 ± 4.3 | 0.81 |
| Example 7 | 121 | 99.5 | 18.6 ± 3.9 | 0.9 |
| Example 8 | 126 | 99.6 | 18.9 ± 4.1 | 0.86 |
| Example 9 | 120 | 99.3 | 21.6 ± 5.3 | 0.84 |
| Example 10 | 113 | 99.5 | 19.4 ± 6.9 | 0.86 |
| Example 11 | 106 | 99.2 | 18.3 ± 3.1 | 0.84 |
| Example 12 | 101 | 99.3 | 17.2 ± 3.6 | 0.91 |
| Example 13 | 93 | 99 | 13.0 ± 2.3 | 0.95 |
| Example 14 | 107 | 99.2 | 16.5 ± 4.8 | 0.95 |
| Example 15 | 91 | 98.8 | 12.9 ± 4.3 | 1.07 |
| Example 16 | 102 | 99.1 | 15.0 ± 4.2 | 1.02 |
| Example 17 | 95 | 98.9 | 14.6 ± 3.4 | 0.98 |
| Comparative | 32 | 96.8 | 10.2 ± 1.4 | 1.25 |
| Example 1 | | | | |
| Comparative | 47 | 97.5 | 10.2 ± 2.4 | 1.24 |
| Example 2 | | | | |
| Comparative | 37 | 97 | 10.2 ± 1.9 | 1.17 |
| Example 3 | | | | |
| Comparative | 4.1 | 75.1 | 8.9 ± 4.0 | 1.32 |
| Example 4 | | | | |
| Comparative | 36 | 97.1 | 15.4 ± 3.7 | 1.16 |
| Example 5 | | | | |

As shown in Table 2 and 3, in Examples 1 to 17, the carbon nanotubes are prepared in a yield of 90 or higher per catalyst unit (gCNT/gcatalyst) by adjusting the amounts of metals. In addition, a higher yield provides a greater diameter and lowers the intensity ratio of the carbon nanotubes on the Raman spectroscopy graph. Thus, the carbon nanotubes can be adjusted in terms of yield and diameter by varying the amounts of metals.

FIG. 4 is a thermal gravimetric analysis (TGA) graph of carbon nanotubes prepared in Example 4. Referring to FIG. 4, unburned inorganic substances remain in an amount of about 0.5% at 650° C., and thus carbon is present in an amount of about 99.5% in the sample. Thus, FIG. 4 illustrates that high purity carbon nanotubes are prepared. (In Example 4, even at a temperature of 650° C. or higher, the content of inorganic residuals is substantially unchanged.)

On the other hand, in Comparative Examples 1 to 5 in which supported catalysts having a mole ratio different from that of Examples 1 to 17 or further including Fe, or Fe and Mo are used, the carbon nanotubes are prepared in a lower yield per catalyst unit and have a reduced diameter and an increased intensity ratio on a Raman spectroscopy graph, as compared with those of Examples 1 to 17.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims.

What is claimed is:

1. Carbon nanotubes comprising: at least one element selected from aluminum (Al), magnesium (Mg) and silicon (Si); and at least one metal selected from cobalt (Co), nickel (Ni), iron (Fe), manganese (Mn) and molybdenum (Mo), the carbon nanotubes having an intensity ratio (ID/IG) of about 1.10 or less as measured by Raman spectroscopy and a carbon purity of about 98% or higher.

2. The carbon nanotubes according to claim 1, wherein the carbon nanotubes comprise about 20 ppm to about 2,000 ppm of aluminum (Al), magnesium (Mg) and/or silicon (Si), about 40 ppm to about 9,000 ppm of cobalt (Co), and about 40 ppm to about 9,000 ppm of manganese (Mn).

3. The carbon nanotubes according to claim 1, wherein the carbon nanotubes have an average particle diameter from about 10 nm to about 35 nm.

4. The carbon nanotubes according to claim 1, wherein the carbon nanotubes have a carbon purity of about 98.5% to about 99.9%.

5. A supported catalyst for preparing carbon nanotubes, comprising: at least one metal catalyst selected from the group consisting of Co, Ni, Fe, Mn and Mo; and at least one support material selected from the group consisting of aluminum oxide, magnesium oxide and silica, the supported catalyst being a hollow type.

6. The supported catalyst according to claim 5, wherein the supported catalyst has an average particle diameter of about 10 μm to about 500 μm.

7. The supported catalyst according to claim 5, wherein the supported catalyst has a mole ratio as follows:
Al, Mg or Si:Co:Mn=1:x:y, wherein about 0.8≦x≦4.0 and about 0.1≦y≦8.0.

8. The supported catalyst according to claim 5, wherein the supported catalyst has a sphericity of about 0.1 to about 1.

9. A method for preparing a supported catalyst, comprising:
providing an aqueous catalyst solution;
spraying the aqueous catalyst solution in droplets; and
baking the sprayed droplets,
wherein the aqueous catalyst solution comprises at least one metal catalyst selected from the group consisting of Co, Ni, Fe, Mn and Mo, and at least one support material selected from the group consisting of aluminum oxide, magnesium oxide and silica.

10. The method according to claim 9, wherein the aqueous catalyst solution has a mole ratio as follows:
Al, Mg or Si:Co:Mn=1:x:y, wherein about 0.8≦x≦4.0 and about 0.1≦y≦8.0.

11. The method according to claim 9, wherein the droplets of the aqueous catalyst solution upon spraying have a size of about 10 μm to about 1000 μm.

12. The method according to claim 9, wherein the aqueous catalyst solution further comprises polyvinylpyrrolidone (PVP), polyvinylalcohol (PVA), polyvinylchloride (PVC), an epoxy-based polymer, or a combination thereof as a polymer binder.

13. The method according to claim 9, wherein baking comprises heat treatment at about 450° C. to about 650° C.

14. A method for preparing carbon nanotubes using the supported catalyst according to claim 5.

15. The method according to claim 14, comprising:
placing the supported catalyst in a furnace; and
preparing carbon nanotubes at about 650° C. to about 750° C. for about 40 to 90 minutes while supplying a carbon source.

16. The method according to claim 15, wherein the carbon source is ethylene, methane, or liquid petroleum gas.

17. The method according to claim 14, wherein the carbon nanotubes are prepared in a yield of about 80 (gCNT/gcatalyst) to about 200 (gCNT/gcatalyst).
